(19) United States
(12) Patent Application Publication
(10) Pub. No.: US 2010/0028712 A1
(43) Pub. Date: Feb. 4, 2010

(54) y'-Ni3Al MATRIX PHASE Ni-BASED ALLOY AND COATING COMPOSITIONS MODIFIED BY REACTIVE ELEMENT CO-ADDITIONS AND Si

(75) Inventor: Brian M. Gleeson, Sewickley, PA (US)

Correspondence Address: SHUMAKER & SIEFFERT, P. A., 1625 RADIO DRIVE, SUITE 300, WOODBURY, MN, 55125, US

(73) Assignee: Iowa State University Research Foundation, Inc.

(21) Appl. No.: 12/183,709

(22) Filed: Jul. 31, 2008

(51) Int. Cl. B32B 15/04; C22C 19/05; B32B 15/01

(52) U.S. Cl. 428/632; 420/443; 420/445; 428/680

(57) ABSTRACT

An alloy including about 16 at % to about 23 at % Al; about 3 at % to about 10 at % Cr; up to about 5 at % Si; up to about 0.3 at % of at least two reactive elements selected from Y, Hf, Zr, La, and Ce; and Ni. The alloy has a volume fraction of γ′-Ni₃Al phase greater than about 75%.

### STATEMENT REGARDING FEDERALLY SPONSORED RESEARCH AND DEVELOPMENT

The U.S. Government has a paid-up license in the presently claimed invention and the right in limited circumstances to require the patent owner to license others on reasonable terms as provided by the terms of Contract Number N00014-02-1-0733, awarded by the Office of Naval Research.

### TECHNICAL FIELD

The present disclosure relates to Ni-based alloy and coating compositions having a γ′-Ni₃Al matrix phase and possessing resistance to high-temperature oxidation and hot-corrosion.

### BACKGROUND

Many high-temperature mechanical systems, such as, for example, gas-turbine engines, produce complex, multi-oxidant gaseous environments that can aggressively degrade the surface of structural components. The resulting multi-oxidant process environments can involve both gaseous and deposit-induced attack. For metallic alloys and coatings, it is often the formation and maintenance of a thermally grown oxide (TGO) scale that is required for surface protection. Alternatively, a stable and durable environmental barrier coating is needed. However, even then it is desirable to have an underlying surface that is capable of forming a reasonably protective TGO scale. The components of high-temperature mechanical systems are often made of a nickel-based superalloy that is based on the γ-Ni+γ′-Ni₃Al phase constitution. Ideally, the high-temperature oxidation and corrosion resistance of the Ni-based superalloy is provided by a TGO scale of Al₂O₃.

U.S. Pat. No. 7,273,662 describes alloy and coating compositions including a Pt-group metal, Ni, Al, and a reactive element such as Hf, wherein the concentration of Al is limited such that the alloy includes substantially no β-NiAl phase. The alloy has a predominately γ+γ′ phase constitution, where γ refers to the solid-solution Ni phase and γ′ refers to the solid-solution Ni₃Al phase. As further described in U.S. Published Application No. US2006/0210825, this alloy or coating composition may optionally include at least one of Cr and Si to further enhance its hot corrosion resistance, while maintaining excellent oxidation resistance. An advantage of these Pt-modified γ+γ′ alloys is their compatibility with superalloy substrates in terms of phase constitution, which in turn can provide minimal coating/substrate inter-diffusion and minimal differences in thermal expansion behavior.

### SUMMARY

Pt-group metals are currently very expensive constituents, which can render the alloys and coating compositions described in U.S. Pat. No. 7,273,662 and U.S. Published Application No. US 2006/0210825 impractical for use in certain applications. The present disclosure relates to γ+γ′ alloy and coating compositions that are free of Pt-group metals. When used as a standalone coating or as a bond coating in a thermal barrier coating (TBC) system on a substrate such as a gas turbine component, these Pt-group metal free compositions can protect the substrate during extended periods of high temperature use, and provide protection comparable to or better than conventional aluminide coatings. The γ+γ′ phase constitution of these compositions is chemically and mechanically compatible with the superalloy substrates commonly used in gas turbine components, and the presently disclosed compositions can be much more cost effective than the Pt-group metal containing materials described in U.S. Pat. No. 7,273,662 and U.S. Published Application No. US 2006/0210825. The alloy and coating compositions are particularly useful as a bond coat layer applied on a superalloy substrate used in a high-temperature resistant mechanical component, or as a non-heat-treatable bulk alloy used in a high temperature application. The alloy and coating compositions described herein exhibit oxidation resistance due to the formation of an Al-rich oxide scale.

In one aspect, the present disclosure is directed to an alloy including about 16 at % to about 23 at % Al; about 3 at % to about 10 at % Cr; up to about 5 at % Si; up to about 0.3 at % of at least two reactive elements selected from Y, Hf, Zr, La, and Ce; and Ni. The alloy has a volume fraction of γ′-Ni₃Al phase greater than about 75%, which separates it from conventional Ni-based superalloys.

In another aspect, the present disclosure is directed to a thermal barrier coated article including a superalloy substrate and a bond coat on the substrate. The bond coat includes about 16 at % to about 23 at % Al; about 3 at % to about 10 at % Cr; up to about 5 at % Si; up to about 0.1 at % Y and up to about 0.2 at % of at least one other reactive element selected from Hf and Zr; and Ni; and wherein the bond coat has a volume fraction of γ′-Ni₃Al phase greater than about 75%.

In yet another aspect, the present disclosure is directed to a thermal barrier coated article including a Ni-based superalloy substrate and a bond coat on the substrate. The bond coat includes about 16 at % to about 23 at % Al; about 3 at % to about 10 at % Cr; up to about 5 at % Si; up to about 0.1 at % Y and up to about 0.2 at % of at least one other reactive element selected from Hf and Zr; and Ni. The bond coat has a volume fraction of γ′-Ni₃Al phase greater than about 75%. The article further includes an adherent layer of oxide on the bond coat and a ceramic coating on the adherent layer of oxide.

In yet another aspect, the present disclosure is directed to an alloy including about 18 at % to about 21 at % Al; about 5 at % to about 8 at % Cr; about 1 at % to about 2 at % Si; about 0.1 at % Y; about 0.2 at % of at least one of Hf and Zr; and Ni. The alloy has a volume fraction of γ′-Ni₃Al phase greater than about 75%.

In another aspect, the present disclosure is directed to a method for making a heat resistant substrate. The method includes applying on the substrate a metallic coating including about 16 at % to about 23 at % Al; about 3 at % to about 10 at % Cr; up to about 5 at % Si; up to about 0.1 at % Y and up to about 0.2 at % of at least one other reactive element selected from Hf and Zr; and Ni. The metallic coating has a volume fraction of γ′-Ni₃Al phase greater than about 75%.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a portion of an 1100+ C. Ni—Al—Cr equilibrium phase diagram showing an embodiment of the alloy and coating compositions described in the present disclosure.

FIG. 2 is a plot of cyclic oxidation kinetics at 1150° C. of an unmodified and various modified Ni-20Al-5Cr alloys. The modifications to the Ni-20Al-5Cr base alloy are indicated in the plots.

FIG. 3 is a plot of cyclic oxidation kinetics at 1150° C. of various modified Ni-20Al-5Cr alloys. The modifications to the Ni-20Al-5Cr base alloy are indicated in the plots. For comparison, the cyclic oxidation of a Pt-modified β-NiAl alloy is included in this plot.

FIG. 4 is a plot of cyclic oxidation kinetics at 1150° C. of a Ni—20Al-5Cr-0.05Hf-0.05Y alloy with (-xSi) and without (w/o) Si addition. As indicated, the Si content, x, is 0.5, 0.1 and 0.2 at %, showing weight change of Ni—Al—Pt alloys of different phase constitutions after “isothermal” exposure at 1150° C. in still air.

FIG. 5 is a comparison of the cyclic oxidation kinetics at 1150° C. in air of a Ni-20Al-5Cr-1Si-0.05Hf-0.05Y alloy to a Ni-20Al-5Cr-1Si-0.05Y alloy.

FIG. 6 is a plot of the cyclic oxidation kinetics at 1150° C. in air of various modified Ni-20Al-5Cr alloys.

FIG. 7 is a plot of the cyclic oxidation kinetics at 1150° C. of Ni-20Al-0.05Hf-0.05Y alloys modified with the indicated Cr or Cr+Si additions.

FIGS. 8A-8B are secondary electron microscope (SEM) images of cross-sections at diffusion couple interfaces after 50 h at 1150° C. The Ni-20Al-5Cr-1Si-0.05Hf-0.05Y coating composition alloy is in the upper portion of each image shown, while the indicated superalloy is in the lower portion.

Like reference symbols in the various drawings indicate like elements. All elemental contents in the figures of this application are in at %.

### DETAILED DESCRIPTION

In one aspect, this disclosure is directed to Ni-based alloy or coating compositions including Al and Cr in amounts selected such that the matrix is γ′-Ni₃Al phase. In the present application this γ′ matrix assemblage means that γ′-Ni₃Al phase is present in a volume fraction of at least 75%. The alloy and coating compositions further include Si and at least two reactive elements selected from Y, Hf, Zr, La and Ce.

The alloy and coating compositions have a volume fraction of γ′-Ni₃Al phase of at least 75%, and include substantially no β-NiAl phase, preferably no β-NiAl phase. In some embodiments, the alloy and coating compositions have γ′-Ni₃Al phase present in a volume fraction of at least about 80%, and in other embodiments the γ′-Ni₃Al phase is present at a volume fraction of at least about 85%, at least about 90%, or at least about 95%. The volume fraction of γ′-Ni₃Al phase can be measured by standard quantitative metallographic techniques. For example, metallographically prepared cross-sections may be viewed under an optical microscope and, assuming that the samples are isotropic in structure, the area fraction of a particular phase constituent may be assumed to be equal to the volume fraction of that phase constituent. Concentration profiles can also be obtained from samples by either energy (EDS) or wavelength (WDS) dispersive spectrometry, with the former utilizing a secondary electron microscope (SEM) and the latter an electron probe micro-analyzer (EPMA).

To provide a γ′ volume fraction in the alloys and coating compositions of greater than about 75%, Al is preferably present at a level greater than about 16 at %. In some embodiments, Al is present in the alloys and coatings at about 16 at % to about 23 at %, and in some embodiments Al is present at about 18 at % to about 21 at %. The atomic percentage (at %) values specified for all elements in this application are nominal, and may vary by as much as ±1-2 at %.

The alloy and coating compositions further include Cr to promote primary formation of a continuous alumina (Al₂O₃) scale, but the Cr content should be limited to avoid formation of the β-NiAl phase. Based on these constraints, in some embodiments Cr is present at about 3 at % to about 10 at %, and in some embodiments Cr is present at about 5 at % to about 8 at %.

The alloy and coating compositions are co-doped with at least two reactive elements such as Hf, Y, La, Ce and Zr. The co-dopants should be present at relatively low concentrations to avoid significant oxidation of the reactive elements, which can be detrimental to cyclic oxidation resistance. In some embodiments the at least two reactive elements are present in the alloy and coating compositions at up to about 0.3 at %. In some embodiments, the reactive elements include up to about 0.1 at % Y and up to about 0.2 at % of at least one other reactive element such as Hf, La, Ce and Zr. In other embodiments, the reactive elements include up to about 0.1 at % Y and up to about 0.2 at % of at least one of Hf and Zr. In other embodiments, the reactive element include about 0.03 at % to about 0.07 at % Y and about 0.03 at % to about 0.12 at % of at least one of Hf and Zr. The reactive element included with Y can be either Hf or Zr or a combination thereof, and Hf is preferred.

The oxidation properties of the alloy and coating compositions can be further improved by addition of up to about 5 at % Si. In some embodiments, Si is present in the alloy and coating compositions at about 1 at % to about 2 at %.

In addition, other typical superalloy constituents such as, for example, Co, Mo, Ta, and Re, and combinations thereof, may optionally be added to or present in the alloy and coating compositions to the extent that at least 75% volume fraction of γ′ phase constitution is present. In some embodiments, up to about 3 at % manganese (Mn) can be added to the alloy and coating compositions to improve corrosion resistance in lower temperature (less than about 1050° C.) applications, depending on the oxidizing environment.

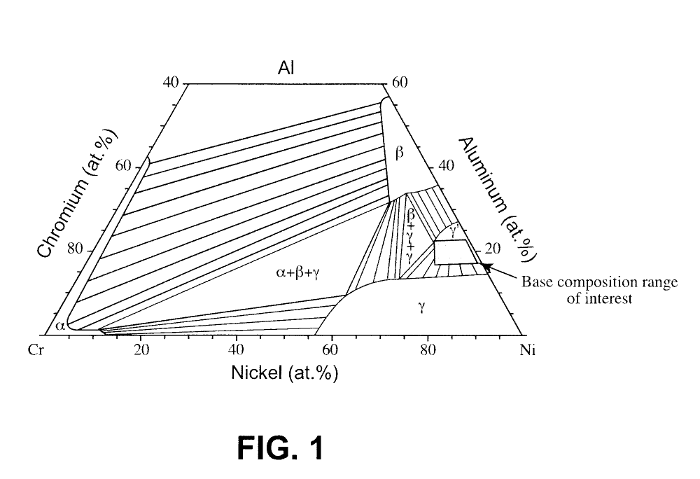

Referring to FIG. 1, a portion of a 1100° C. Ni—Al—Cr equilibrium phase diagram is shown in which the Al and Cr concentrations are selected with respect to the concentration of Ni such that the ternary alloy falls within the shaded region referred to the as the base composition range of interest, which corresponds to the Al-rich portion of the γ-Ni+γ′-Ni₃Al phase field. This shaded region represents the basis for the disclosed alloy and coating compositions. By being in the Al-rich portion of the γ+γ′ phase field, the resulting microstructures are predominantly γ′, to the extent that γ′ is the matrix phase and includes at least 75% of the alloy microstructure. Accordingly, the disclosed compositions are outside the range of Ni-based superalloys, which typically include a γ-Ni matrix and include about 30% γ′ if it is a wrought alloy or about 65% γ′ if it is cast.

The alloys may be prepared by conventional techniques such as, for example, argon-arc melting pieces of high-purity Ni, Al, Cr and optional reactive and/or superalloy metals and combinations thereof.

The compositions described herein may be applied on a substrate as high temperature resistant coatings (as stand-alone metallic coatings or as a bond coating in a thermal barrier coating (TBC) system), and may also be used as non-heat treatable bulk alloys. Any conventional Ni- or Co-based superalloy may be used as the substrate, including, for example, those available from Martin-Marietta Corp., Bethesda, Md., under the trade designation MAR-M 002; those available from Cannon-Muskegon Corp., Muskegon, Minn., under the trade designation CMSX-4, CMSX-10, and the like.

The coating compositions may be applied to the substrate using any known process, including for example, plasma spraying, chemical vapor deposition (CVD), physical vapor deposition (PVD) and sputtering to create a coating and form a temperature-resistant article. Typically this deposition step is performed in an evacuated chamber.

The thickness of the coating may vary widely depending on the intended application, but typically will be about 5 μm to about 100 μm, preferably about 5 μm to about 50 μm, and most preferably about 10 μm to about 50 μm.

If the coating is a bond coat layer in a TBC system, a layer of ceramic typically consisting of partially stabilized zirconia may then be applied using conventional PVD processes on the bond coat layer to form a ceramic topcoat. Suitable ceramic topcoats are available from, for example, Chromalloy Gas Turbine Corp., Delaware, USA. The deposition of the ceramic topcoat layer conventionally takes place in an atmosphere including oxygen and inert gases such as argon. The presence of oxygen during the ceramic deposition process makes it inevitable that a thin oxide scale layer is formed on the surface of the bond coat. The thermally grown oxide is typically an adherent layer of alumina, α-Al₂O₃. The bond coat layer, the TGO layer and the ceramic topcoat layer form a thermal barrier coating system on the superalloy substrate.

The alloy compositions described herein, when utilized as a coating layer, are both chemically and mechanically compatible with typical Ni- and Co-based superalloys. Protective coatings formulated from these compositions will have coefficients of thermal expansion (CTE) that are more compatible with the CTEs of Ni-based superalloys than those of β-NiAl-containing coatings. The former, when used as a bond coating, would provide enhanced thermal barrier coating stability during the repeated and severe thermal cycles experienced by mechanical components in high-temperature mechanical systems.

When thermally oxidized, the compositions described herein grow an α-Al₂O₃-rich scale layer at a rate comparable to or slower than the TGO scale layers formed on conventional aluminides, such as Pt-modified β-NiAl, and this provides excellent oxidation resistance.

The compositions described herein may be applied as a coating to any metallic part to provide resistance to severe thermal conditions and salt-induced hot corrosion. Suitable metallic substrate parts include Ni- and Co-based superalloy components for gas turbines, particularly those used in aeronautical and marine engine applications.

In addition, the alloys described herein may be used in bulk alloy form such as, for example, foils, sheets, and the like, to take advantage of the high-temperature oxidation and hot corrosion resistant properties that the alloys provide.

The alloy and coating compositions described herein may be used in an as-fabricated “bare” state or with a “pre-formed” thermally grown oxide layer on the surface. With regard to the latter, the alloy or coating can be exposed to an oxidizing atmosphere at an elevated temperature so as to cause a reaction leading to the formation of an oxide scale layer. This scale layer will be rich in Al₂O₃.

The alloy and coating compositions will now be described with reference to the following non-limiting examples.

### EXAMPLES

### Example 1

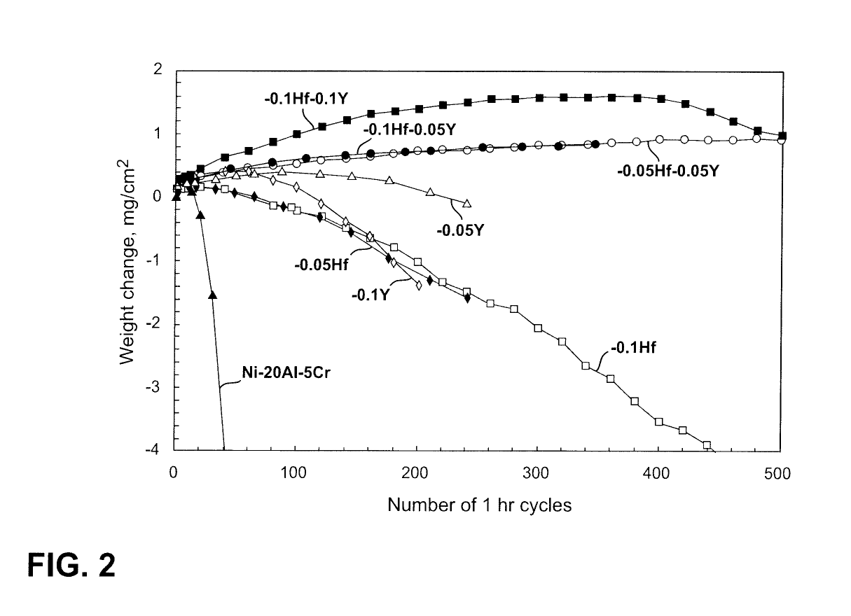

FIG. 2 shows cyclic oxidation kinetics in air of an unmodified and various modified Ni-20Al-5Cr γ+γ′ alloys (all compositions in the examples in this application will be given in atomic percent (at. %)) having a γ′ volume fraction of about 85-95%. Each thermal cycle consisted of one hour at 1150° C. followed by 15 minutes at approximately 80° C. In FIG. 2, weight loss (i.e., a negative slope in a kinetics plot) is an unwanted consequence of scale spallation. It is seen that single doping with a single reactive element (i.e., Y or Hf) or co-doping with at least two reactive elements (i.e., Y+Hf in this example) is beneficial to the cyclic oxidation resistance of the base alloy. Moreover, Y+Hf co-doping, particularly at 0.05 Y+0.05 or 0.1 Hf, is highly beneficial, to the extent that virtually no weight loss is measured over the course of 500 one-hour thermal cycles. These data indicate that it is not the amount of reactive element that matters, but rather it is the synergism of Y and Hf together that leads to a highly beneficial effect. For instance, the alloy with 0.05Y+0.05Hf is far superior to the alloy with either 0.1Y or 0.1Hf, even though all alloys have a reactive element content of 0.1 at %.

The equilibrated samples were first analyzed using X-ray diffraction (XRD) for phase identification and then prepared for metallographic analyses by cold mounting them in an epoxy resin followed by polishing to a 0.5 μm finish. Microstructure observations were initially carried out on etched samples using an optical microscope. Concentration profiles were obtained from un-etched (i.e., re-polished) samples by either energy (EDS) or wavelength (WDS) dispersive spectrometry, with the former utilizing a secondary electron microscope (SEM) and the latter an electron probe micro-analyzer (EPMA). Differential thermal analysis (DTA) was also conducted on selected samples to determine thermal stability of different phases.

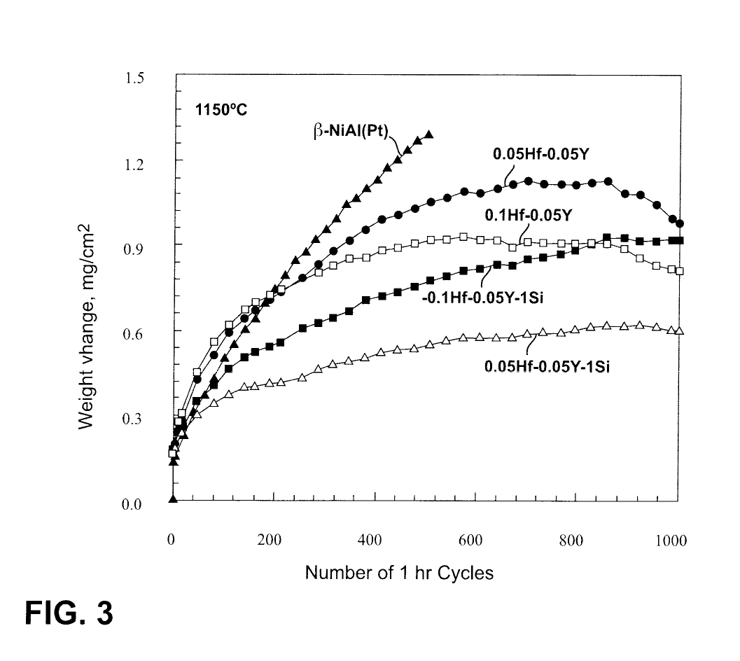

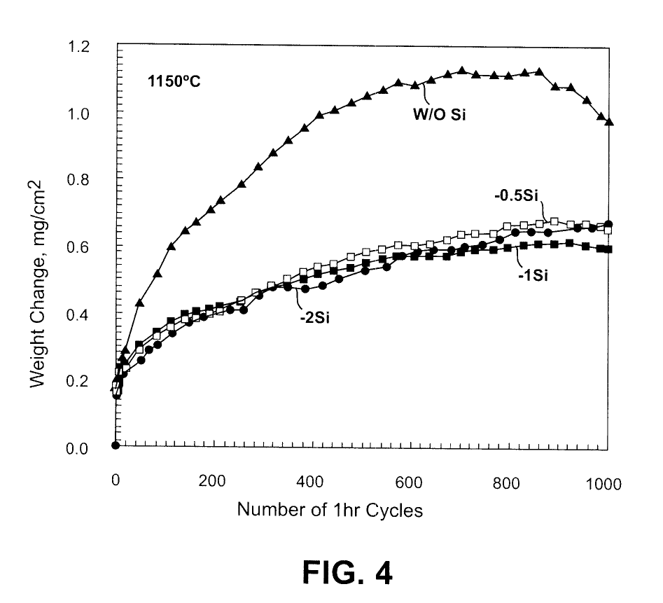

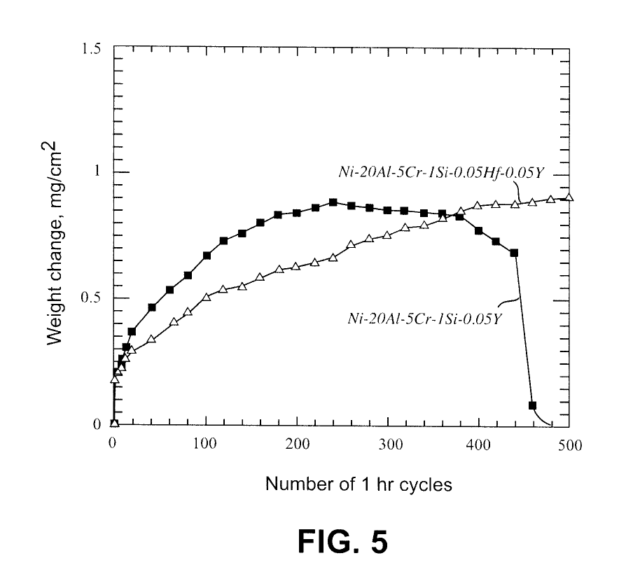

FIG. 3 shows cyclic oxidation kinetics in air of various modified Ni-20Al-5Cr γ+γ′ alloys. Each thermal cycle consisted of one hour at 1150° C. followed by 15 minutes at approximately 80° C. The total number of thermal cycles was 1000 (cf. 500 in FIG. 2). It is seen that the benefits of 1 at % Si addition to a Y+Hf-modified γ+γ′ alloy are twofold. First, the short-term (less than 100 cycles) oxidation kinetics of a Ni-20Al-5Cr alloy doped with either 0.05Hf+0.05Y or 0.1Hf+0.05Y is significantly reduced by the addition of Si. Second, the Si addition to these alloys improves scale adhesion, as evidenced by the minimal weight loss of the Si+Hf+Y-modified alloys in comparison to the counterpart Hf+Y modified alloys when exposed beyond about 800 one-hour thermal cycles. FIG. 4 shows that the addition of 0.5 to 2 at % Si results in a similar-and significant-benefit to the cyclic oxidation resistance of a Ni-20Al-5Cr-0.05Hf-0.05Y base alloy. FIG. 5 shows the highly beneficial effect of Si addition is manifested when the base alloy is co-doped with a reactive elements (i.e., Y+Hf) as opposed to being single doped (i.e., Y only).

### Example 2

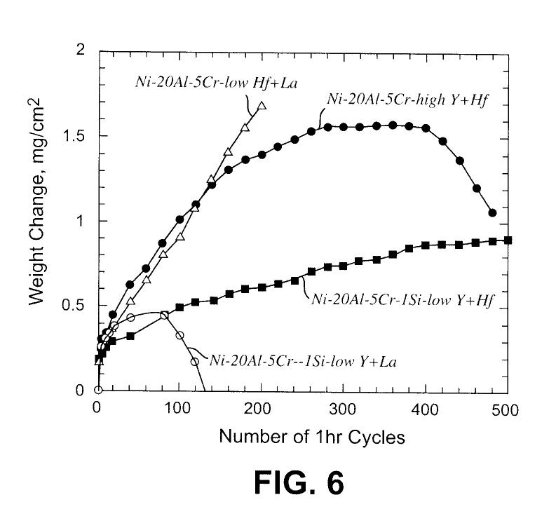

FIG. 6 shows cyclic oxidation kinetics in air of various modified Ni-20Al-5Cr γ+γ′ alloys. Each thermal cycle consisted of one hour at 1150° C. followed by 15 minutes at approximately 80° C. The modifications specifically pertain to combined reactive-element (i.e., Y, Hf and La) additions at different levels. It is seen in FIG. 6 that the best performing alloy-by a significant margin-is the one modified by a relatively low level of Y+Hf (i.e., 0.05Y+0.05Hf). This “low Y+Hf” alloy further benefits from containing 1 at % Si.

### Example 3

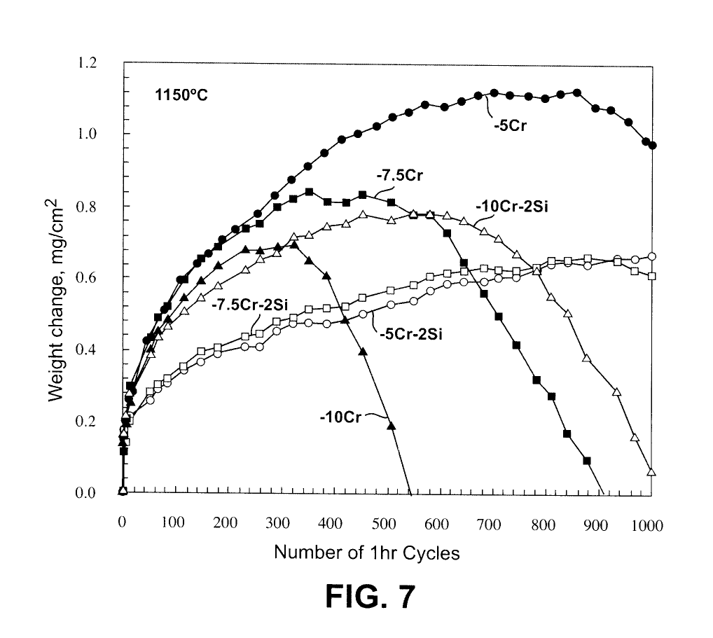

FIG. 7 shows the effects of Cr content on the cyclic oxidation kinetics in air of Ni-20Al-0.05Hf-0.05Y γ+γ′ alloys with and without 2 at % Si addition. Each thermal cycle consisted of one hour at 1150° C. followed by 15 minutes at approximately 80° C. It is seen in FIG. 6 that alloys containing 10 at % Cr undergo weight loss, which is due to scale spallation, after a certain number of thermal cycles, the occurrence of which is extended by the addition of Si. The alloys with 10 at. % Cr contained a small amount of β-NiAl in addition to the γ-Ni and γ′-Ni₃Al phases, suggesting that the Cr content should preferably be less than 10 at % in order to avoid β phase formation and, in turn, optimize cyclic oxidation resistance. The results in FIG. 7 also further show the significant benefits of adding Si to an Hf+Y co-doped alloy.

### Example 4

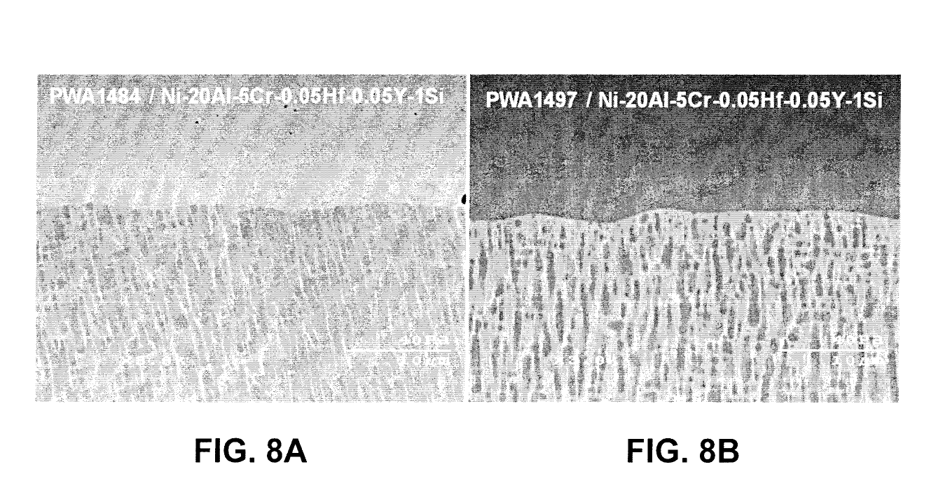

FIG. 8A and FIG. 8B are cross-sectional images of diffusion couples after 50 hours at 1150° C. Each couple shown in FIG. 8 had one end consisting of an alloy made of the Ni-20Al-5Cr-1Si-0.05Hf-0.05Y coating composition. In FIG. 8A, the lower half was the second generation Ni-based superalloy available under the trade designation PWA 1484 from Pratt & Whitney, a United Technologies company, while in the second couple of FIG. 8B the lower half was the fourth generation Ni-based superalloy available under the trade designation PWA 1497 from Pratt & Whitney. The superalloys are in the bottom portion of the images shown in FIGS. 8A-8B. It is seen that two superalloys are highly compatible with the coating composition, with no apparent formation of an interdiffusion reaction zone. More specifically, there was no formation of unwanted topologically close-packed (TCP) phases or a secondary reaction zone (SRZ). These results are in stark contrast to the reaction zones formed in couples of superalloys mated to conventional β-NiAl-containing coating compositions.

A number of embodiments of the invention have been described. Nevertheless, it will be understood that various modifications may be made without departing from the spirit and scope of the invention. Accordingly, other embodiments are within the scope of the following claims.

What is claimed is:

1. An alloy comprising about 16 at % to about 23 at % Al; about 3 at % to about 10 at % Cr; up to about 5 at % Si; up to about 0.3 at % of at least two reactive elements selected from Y, Hf, Zr, La, and Ce; and Ni, wherein the alloy has a volume fraction of γ′-Ni₃Al phase greater than about 75%.

2. The alloy of claim 1, wherein the alloy comprises up to about 0.1 at % Y and up to about 0.2 at % of at least one other reactive element selected from Hf and Zr.

3. The alloy of claim 2, wherein the alloy comprises about 0.03 at % to about 0.07 at % Y and about 0.03 at % to about 0.12 at % of the at least one other reactive element selected from Hf and Zr.

4. The alloy of claim 3, wherein the other reactive element is Hf.

5. The alloy of claim 1, wherein the alloy comprises about 5 at % to about 8 at % Cr.

6. The alloy of claim 1, wherein the alloy comprises about 1 at % to about 2 at % Si.

7. The alloy of claim 1, wherein the alloy comprises about 18 at % to about 21 at % Al.

8. The alloy of claim 1, further comprising at least one metal selected from Co, Mo, Ta, and Re.

9. The alloy of claim 1, further comprising up to about 3 at % Mn.

10. A coating composition comprising the alloy of claim 1.

11. A metal coated with the composition of claim 9.

12. A thermal barrier coated article comprising a superalloy substrate and a bond coat on the substrate, wherein the bond coat comprises about 16 at % to about 23 at % Al; about 3 at % to about 10 at % Cr; up to about 5 at % Si; up to about 0.1 at % Y and up to about 0.2 at % of at least one other reactive element selected from Hf and Zr; and Ni; and wherein the bond coat has a volume fraction of γ′-Ni₃Al phase greater than about 75%.

13. The article of claim 12, wherein the bond coat comprises about 0.03 at % to about 0.07 at % Y and about 0.03 at % to about 0.12 at % of the at least one other reactive element selected from Hf and Zr.

14. The article of claim 13, wherein the other reactive element is Hf.

15. The article of claim 12, wherein the bond coat comprises about 5 at % to about 8 at % Cr.

16. The article of claim 12, wherein the bond coat comprises about 1 at % to about 2 at % Si.

17. The article of claim 12, wherein the bond coat comprises about 18 at % to about 21 at % Al.

18. The article of claim 12, wherein the bond coat further comprises at least one metal selected from Co, Mo, Ta, and Re.

19. The article of claim 12, wherein the bond coat further comprising up to about 3 at % Mn.

20. A thermal barrier coated article comprising:
(a) a Ni-based superalloy substrate;
(b) a bond coat on the substrate, wherein the bond coat comprises about 16 at % to about 23 at % Al; about 3 at % to about 10 at % Cr; up to about 5 at % Si; up to about 0.1 at % Y and up to about 0.2 at % of at least one other reactive element selected from Hf and Zr; and Ni, and wherein the bond coat has a volume fraction of γ′-Ni₃Al phase greater than about 75%;
(c) an adherent layer of oxide on the bond coat; and
(d) a ceramic coating on the adherent layer of oxide.

21. The article of claim 20, wherein the bond coat has a thickness of about 5 μm to about 100 μm.

22. The article of claim 20, wherein the bond coat has a thickness of about 10 μm to about 50 μm.

23. An alloy comprising about 18 at % to about 21 at % Al; about 5 at % to about 8 at % Cr; about 1 at % to about 2 at % Si; about 0.1 at % Y; about 0.2 at % of at least one of Hf and Zr; and Ni, wherein the alloy has a volume fraction of γ′-Ni₃Al phase greater than about 75%.

24. The alloy of claim 23, wherein the alloy comprises about 0.03 at % to about 0.07 at % Y and about 0.03 at % to about 0.12 at % of the at least one other reactive element selected from Hf and Zr.

25. The alloy of claim 23, wherein the alloy comprises about 0.03 at % to about 0.07 at % Y and about 0.03 at % to about 0.12 at % of Hf.

26. The alloy of claim 23, further comprising at least one metal selected from Co, Mo, Ta, and Re.

27. The alloy of claim 23, further comprising up to about 3 at % Mn.

28. A coating composition comprising the alloy of claim 23.

29. A metal coated with the composition of claim 28.

30. A method for making a heat resistant substrate comprising applying on the substrate a coating comprising about 16 at % to about 23 at % Al; about 3 at % to about 10 at % Cr; up to about 5 at % Si; up to about 0.1 at % Y and up to about 0.2 at % of at least one other reactive element selected from Hf and Zr; and Ni, wherein the bond coat has a volume fraction of γ′-Ni₃Al phase greater than about 75%.

31. The method of claim 30, wherein the alloy comprises about 0.03 at % to about 0.07 at % Y and about 0.03 at % to about 0.12 at % of the at least one other reactive element selected from Hf and Zr.

32. The method of claim 31, wherein the other reactive element is Hf.

33. The method of claim 30, wherein the alloy comprises about 5 at % to about 8 at % Cr.

34. The method of claim 30, wherein the alloy comprises about 1 at % to about 2 at % Si.

35. The method of claim 30, wherein the alloy comprises about 18 at % to about 21 at % Al.

36. The method of claim 30, wherein the alloy further comprises at least one metal selected from Co, Mo, Ta, and Re.

37. The method alloy of claim 30, wherein the alloy further comprising up to about 3 at % Mn.
